(19) United States
(12) Patent Application Publication
(10) Pub. No.: US 2015/0167342 A1
(43) Pub. Date: Jun. 18, 2015

(54) Self-Climbing Telescopic Crane and Method for Mounting Pre-Fabricated Concrete Towers

(71) Applicant: Jesus Montaner Fraguet, Huesca (ES)

(72) Inventor: Jesus Montaner Fraguet, Huesca (ES)

(73) Assignee: STRUCTURAL RESEARCH, S.L., Huesca (ES)

(21) Appl. No.: 14/401,788

(22) PCT Filed: May 17, 2013
(86) PCT No.: PCT/ES2013/070316

§ 371 Date: Nov. 17, 2014

(30) Foreign Application Priority Data
May 18, 2012 (ES) 201230754

(51) Int. Cl. E04H 12/34; B66C 23/30; B66C 23/18; B66C 23/70; B66C 23/06

(52) U.S. Cl. CPC E04H 12/342; B66C 23/701; B66C 23/06; B66C 23/185; B66C 23/30

(57) ABSTRACT

Self-climbing, telescopic crane and a method for mounting pre-fabricated concrete towers of the type formed by a plurality of modules joined laterally to form diverse frustroconical segments that are subsequently stacked to form the tower, that comprises an external vertical column and another internal one that can move vertically via actuators. The top part of the internal vertical column terminates in a horizontally rotatable capstan, associated with a horizontal arm terminating at the opposite end in a pulley through which the hoist cable moves. The invention presented affords the main advantage of allowing mounting from inside the tower, dispensing with the need of expensive long-reach cranes to be operating over long periods, with a notable reduction in the economic cost and the mounting time of the tower, as well as allowing mounting to be carried out in unfavourable wind conditions.

The present description relates, as its title indicates, to a self-climbing telescopic crane and a method for mounting pre-fabricated concrete towers of the type formed by a plurality of modules joined laterally to form diverse frustroconical segments that are subsequently stacked to form the tower, that comprises an external vertical column and an internal column that can move vertically via one or several actuators. The top part of the internal vertical o column terminates in a horizontally rotatable capstan, associated with a horizontal arm terminating at the opposite end in a pulley through which the hoist cable moves.

### BACKGROUND OF THE INVENTION

Currently various types of modular pre-fabricated concrete towers are known, mainly of the type used as a support for very tall wind turbines and other uses, which typically employ pre-fabricated reinforced concrete elements of a reduced thickness, in some cases reinforced with an internal structure of horizontal and vertical ribs, the elements in some towers being tensioned, both horizontally and vertically, by means of flexible metal cables.

References to several examples of these embodiments can be found, such as for example Patents ES 1058539 “Perfected structure of modular tower for wind turbines and other applications”, ES 2246734 “Pre-fabricated modular tower”, ES 2296531 “Tower for wind turbines mounted with pre-fabricated elements” and ES 2234392 “Process for mounting a wind turbine tower and tower thus constructed”. All of them share a similar, known and commonly used procedure that is described in Patent ES 232610 “Structure and mounting procedure of concrete towers for wind turbines”, in which the pre-fabricated concrete elements that form each section or segment of the tower are temporarily held in place by using variable length props positioned in an inclined way between the top part of the pre-fabricated concrete elements and the foundation.

This conventional technique causes considerable problems given that the inclined props take up a large proportion of the interior working space, preventing the use of work platforms or similar devices inside, which makes it enormously difficult and, in some cases, prevents the work of the operators inside the tower that is necessary for horizontal cable tensioning operations, sealing of joints and coupling between section segments and between the sections, obliging them to work using platforms or harnesses suspended from cables supported by cranes from the outside. In addition to causing delays in work, this situation entails a considerable occupational hazard for operators.

Other solutions have been sought, such as, for example, that described in Patent ES 201230433/8 “Mounting structure for pre-fabricated concrete towers”, which presents an internal structure formed by a vertical column fitted, on its top part, with a plurality of telescopic horizontal bracing members, and which also has a work platform for the operators, that moves vertically on the vertical column, all of the elements that form the structure being located inside the section of the tower in the process of being mounted, allowing the work pieces to be mechanically supported at the same time as the operators carry out manual work inside. This embodiment resolves some of the problems encountered in the previous ones, but it still has the considerable drawback of requiring the use of long-reach cranes to lift and position the modular concrete elements, entailing a high economic cost due to their large dimensions and the power required. In addition, lifting and positioning the elements requires considerable accuracy and is quite sensitive to the wind, which is of particular importance in locations of towers for wind turbines, which are selected for being sites where the wind has a great impact, resulting in very few useful days for mounting, considerably prolonging the time needed to mount the towers.

### DESCRIPTION OF THE INVENTION

To resolve the current problems that exist in mounting pre-fabricated concrete towers of the type formed by a plurality of modules that are joined laterally to form various frustoconical segments that are subsequently stacked to form the tower, the self-climbing telescopic crane and method of mounting pre-fabricated concrete towers, which is the object of this invention, has been devised, which comprises an external vertical column and an internal vertical column that can move vertically via one or several actuators. The top part of the internal vertical column terminates in a horizontally rotatable capstan, associated with a horizontal arm terminating at the opposite end in a pulley through which the hoist cable moves.

The horizontal arm associated with the capstan may be of the telescopic or variable inclination type, in both cases enabling the effective length of the arm to be altered.

In all or in some of the mounting phases, the optional use of an auxiliary work platform is envisaged, moving vertically and horizontally inside the tower, allowing the operators to perform the internal tasks of coupling, concreting, tensioning cables and sealing between the pre-fabricated concrete elements.

This telescopic, self-bearing crane enables its use inside the tower that is to be mounted, by means of a typical work method, in which the pre-fabricated concrete elements that form each section are hoisted, guided by one or several guide rails installed on the outside of some of the pre-fabricated concrete elements, via one or several skids or rollers, which, hereafter shall be referred to as rollers.

Furthermore, operators can descend the outside of the tower to carry out tasks of sealing and finishing the outside as well as, if necessary, to dismantle both the guide rails and the rollers once they have been used.

### ADVANTAGES OF THE INVENTION

The self-climbing telescopic crane and method for mounting pre-fabricated concrete towers that is presented affords numerous advantages over the systems currently available, the most outstanding being that because it is telescopic and self-bearing, it allows the tower to be mounted from the inside of the same, dispensing with the need for expensive, long-reach cranes to be operating for long periods.

Another important advantage is that, thanks to the low cost of the crane and the fact that long-reach cranes are not required, a significant reduction is achieved in the cost of mounting the tower.

Another advantage of this invention is that, as it is supported inside the tower and on the tower itself, sheltered from the wind, and because the elevating of the parts is guided by one or several guide rails, mounting of the tower can be carried out in wind conditions in which it is not possible with conventional mounting methods.

Another of the most important advantages to be highlighted is that given its telescopic and self-climbing nature, it is the very crane that elevates itself between the different tower sections, being able to mount a tower of any height with a two-segment crane that is just slightly higher than one section when stowed.

A further added advantage is that thanks to its reduced size it is easily transportable and reusable for mounting other towers.

It is important to underline that using it for mounting dispenses with the need for large external cranes, with the consequent economic savings on tower mounting.

Along the same lines, the use of an auxiliary crane structure that is transportable and reusable, to be set up beside the tower, has been envisaged, to be optionally used in the dismantling of the telescopic, self-climbing crane, allowing it to be reused in the elevation of another or other towers.

This invention allows greater speed in mounting, enabling the elevation of one section per day, even in windy conditions.

### DESCRIPTION OF THE FIGURES

To gain a better understanding of the object of this invention, the attached drawing shows a preferred practical embodiment of a self-climbing telescopic crane and method for mounting pre-fabricated concrete towers.

In said drawing, FIG. 1—shows a side view of the crane, in its preferred embodiment with the horizontal telescopic arm.

FIG. 2—shows a side view of the top part of the crane, in its alternative embodiment with the inclinable horizontal arm.

FIG. 3—shows a side view of the first phase of mounting the crane, in its preferred embodiment with the horizontal telescopic arm.

FIG. 4—shows a side view of the second phase of mounting the first section of the tower, in its preferred embodiment with the horizontal telescopic arm.

FIG. 5—shows a side view of the third phase of elevation of the crane, in its preferred embodiment with the horizontal telescopic arm.

FIG. 6—shows a side view of the fourth phase of mounting the following section of the tower, in the second step, in its preferred embodiment with the telescopic horizontal arm.

FIG. 7—shows a plan view of the fourth phase of mounting the following section of the tower, in the second step, with an enlarged detail of guiding between a roller and a guide rail

FIG. 8—shows a side view of the fourth phase of mounting the following section of the tower, in the third step, in its preferred embodiment with the telescopic horizontal arm.

FIG. 9—shows a side view of the fourth phase of mounting the following section of the tower, in the fifth step, in its preferred embodiment with the telescopic horizontal arm.

FIG. 10—shows a side view of the fourth phase of mounting the following section of the tower, in the seventh step, in its preferred embodiment with the telescopic horizontal arm.

FIG. 11—shows a side view upon completion of the fourth phase of mounting the following section of the tower, in its preferred embodiment with the telescopic horizontal arm.

FIG. 12—shows a side view of the fifth phase of hoisting the crane, in the first step, in its preferred embodiment with the horizontal telescopic arm.

FIG. 13—shows a side view of the fifth phase of hoisting the crane already completed, in its preferred embodiment with the horizontal telescopic arm.

FIG. 14—shows a side view of the sixth phase of dismantling the crane, showing the stage of elevating the auxiliary crane structure.

FIG. 15—shows a side view of the sixth phase of dismantling the crane, showing the auxiliary crane structure already mounted on the side of the tower, in the dual-arm embodiment, with the arms deployed.

FIG. 16—shows a side view of the sixth phase of dismantling the crane, showing the auxiliary crane structure already mounted on the side of the tower, in the horizontal arm embodiment.

FIG. 17—shows a side view of the sixth phase of dismantling the crane, showing the auxiliary crane structure already mounted on the side of the tower and with the self-climbing telescopic crane already dismantled and removed, at the stage of elevating the nacelle.

FIG. 18—shows a side view of the sixth phase of dismantling the crane, showing the auxiliary crane structure already mounted on the side of the tower and with the self-climbing telescopic crane already dismantled and removed, with the nacelle already mounted on the tower.

FIG. 19—shows a side view of the sixth phase of dismantling the crane, showing the auxiliary crane structure already mounted on the side of the tower and with the self-climbing telescopic crane already dismantled and removed, at the stage of elevating the blades.

FIG. 20—shows a side view of the sixth phase of dismantling the crane, showing the auxiliary crane structure already mounted on the side of the tower and with the self-climbing telescopic crane already dismantled and removed, at the stage of elevating the blades.

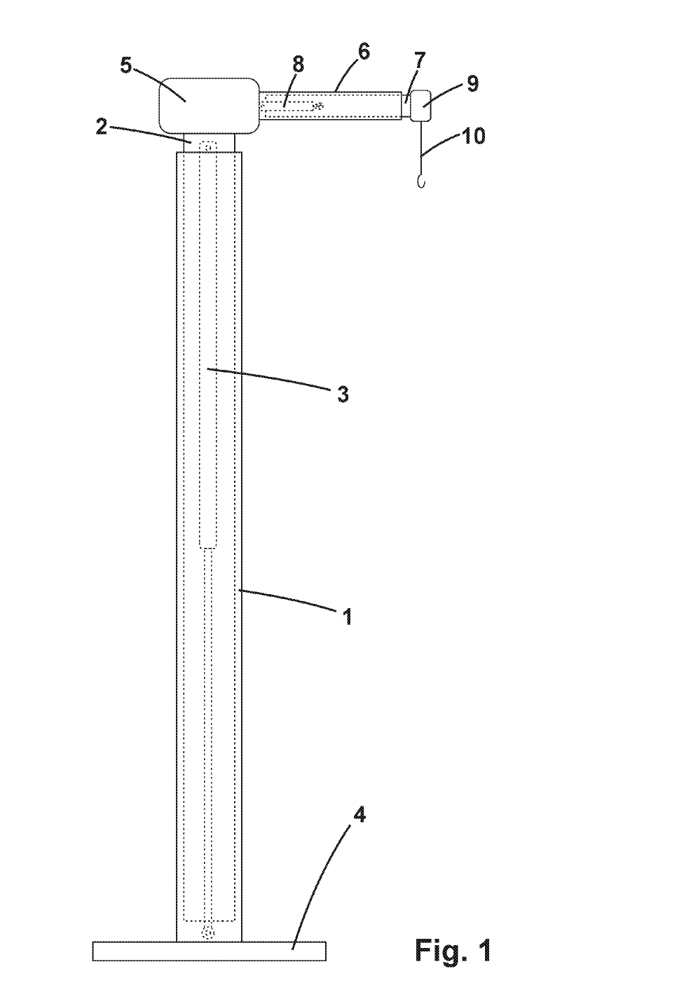

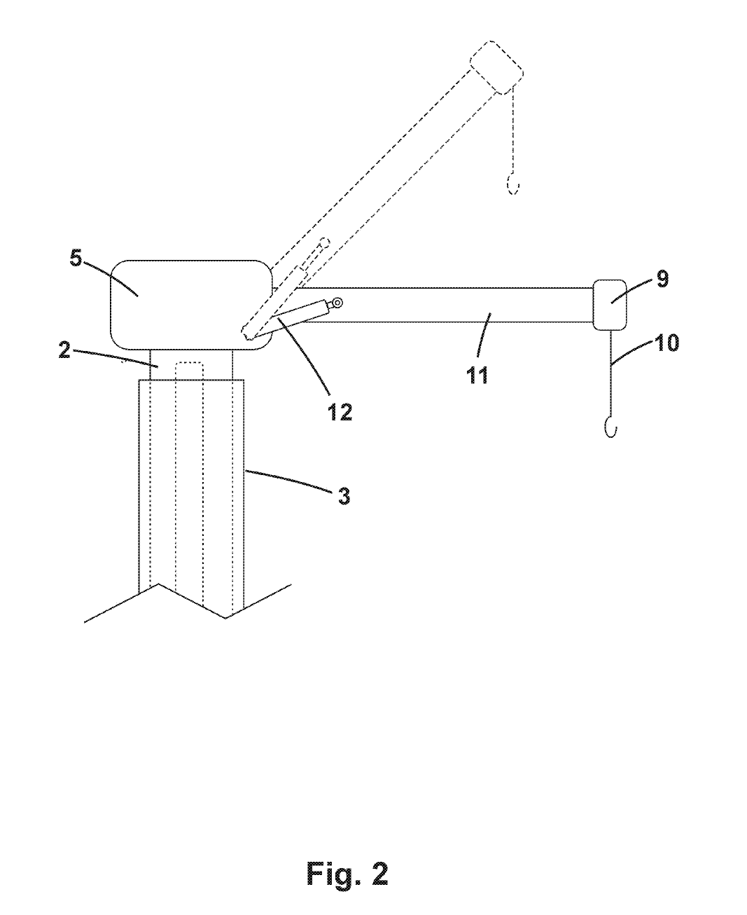

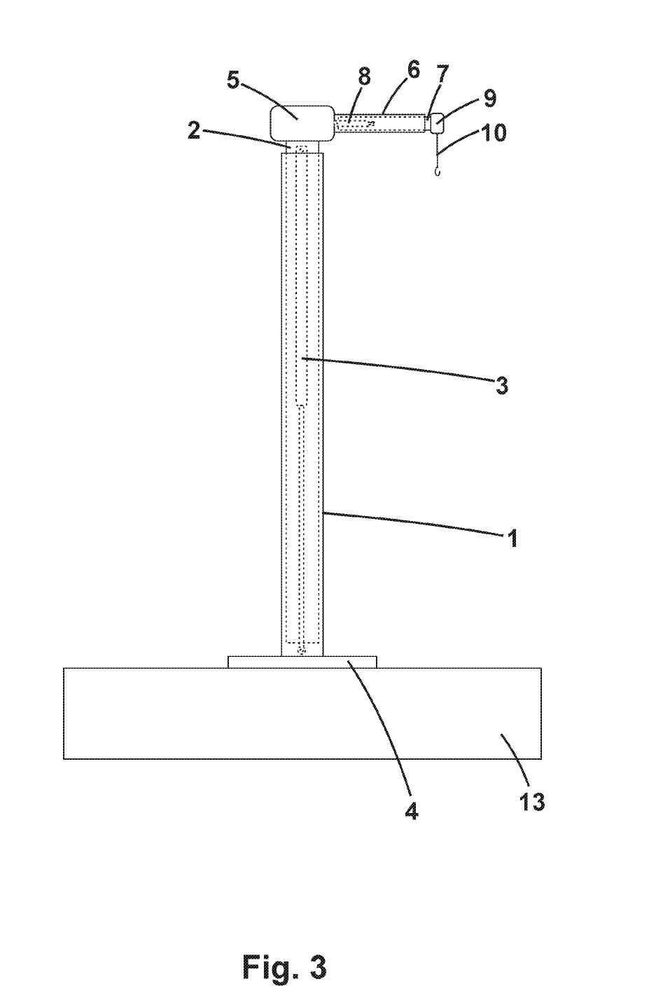

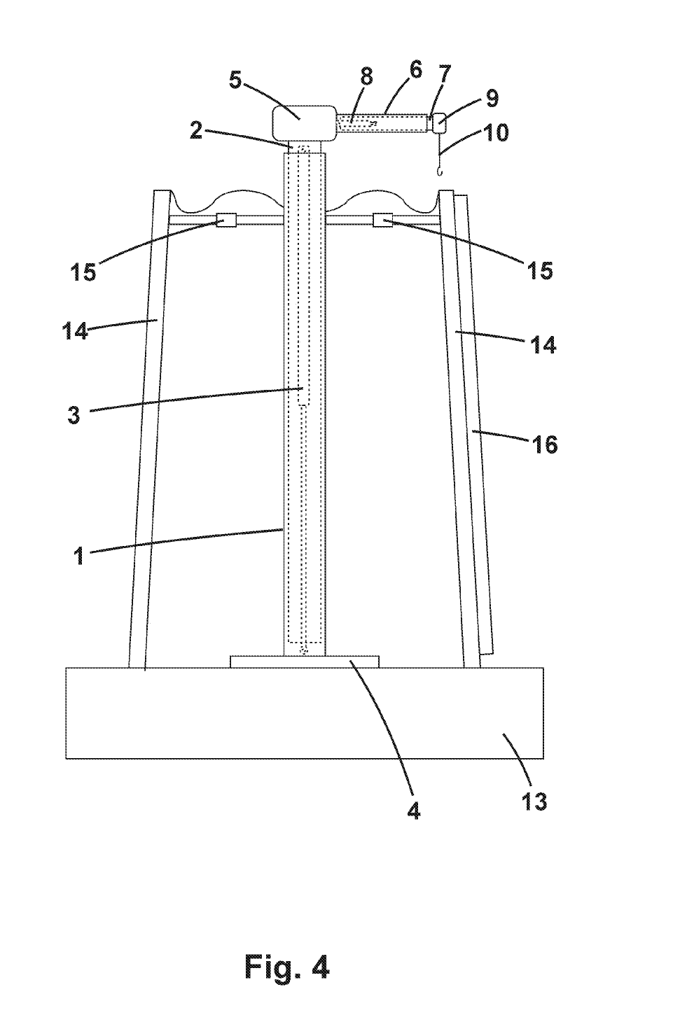

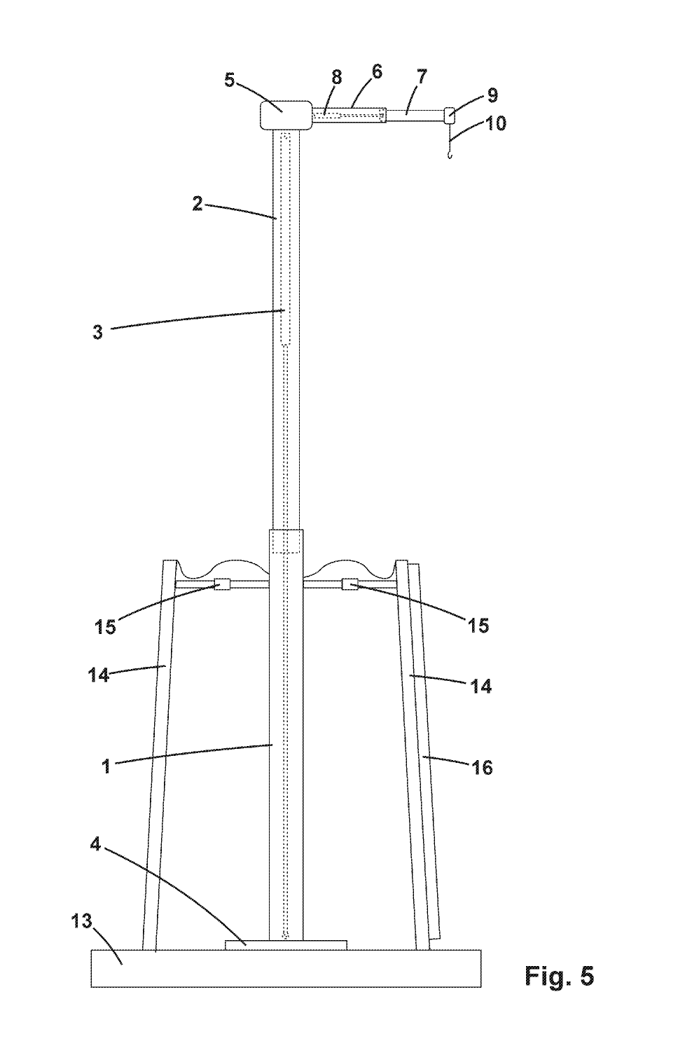

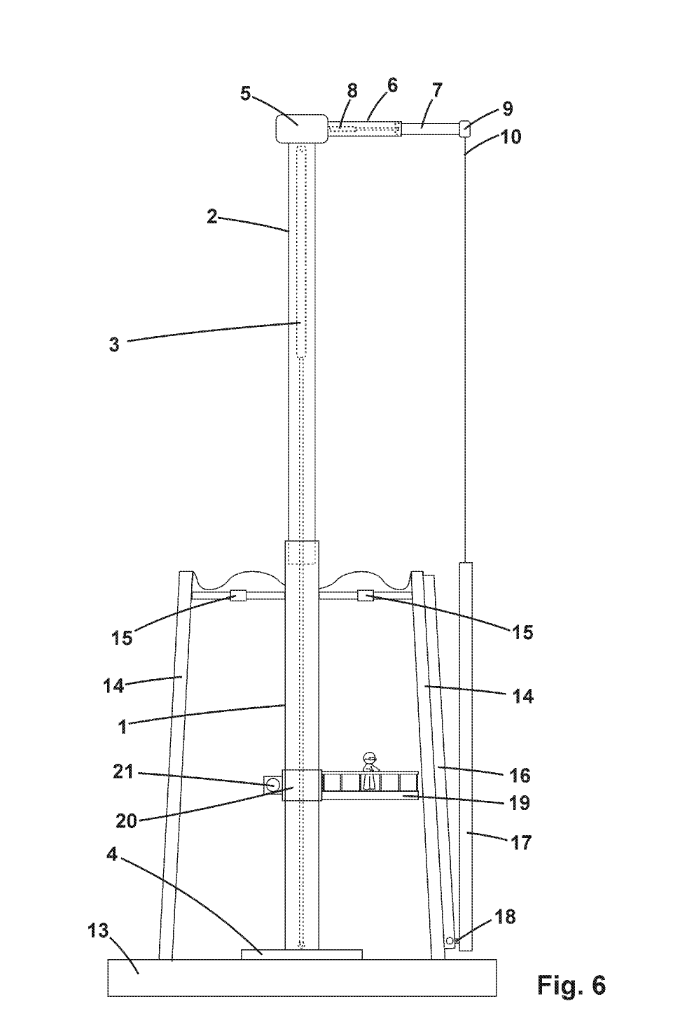

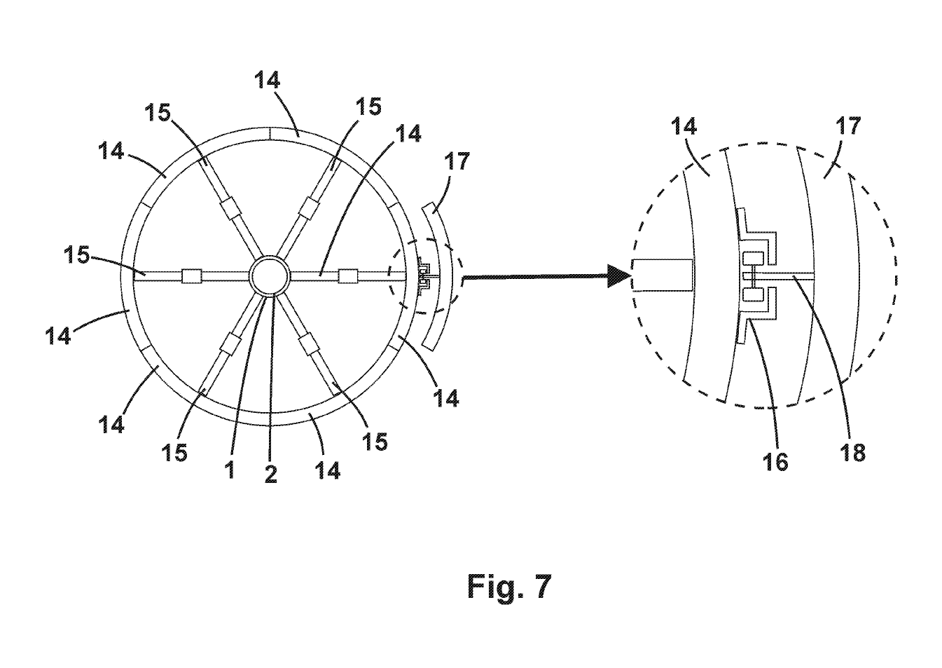

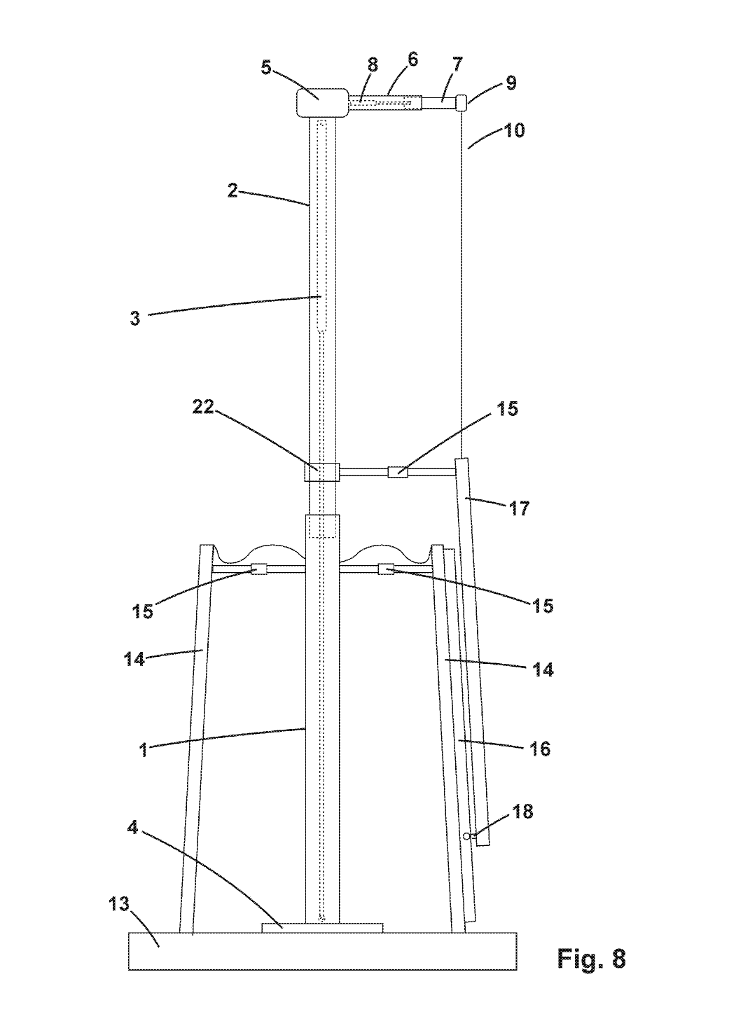

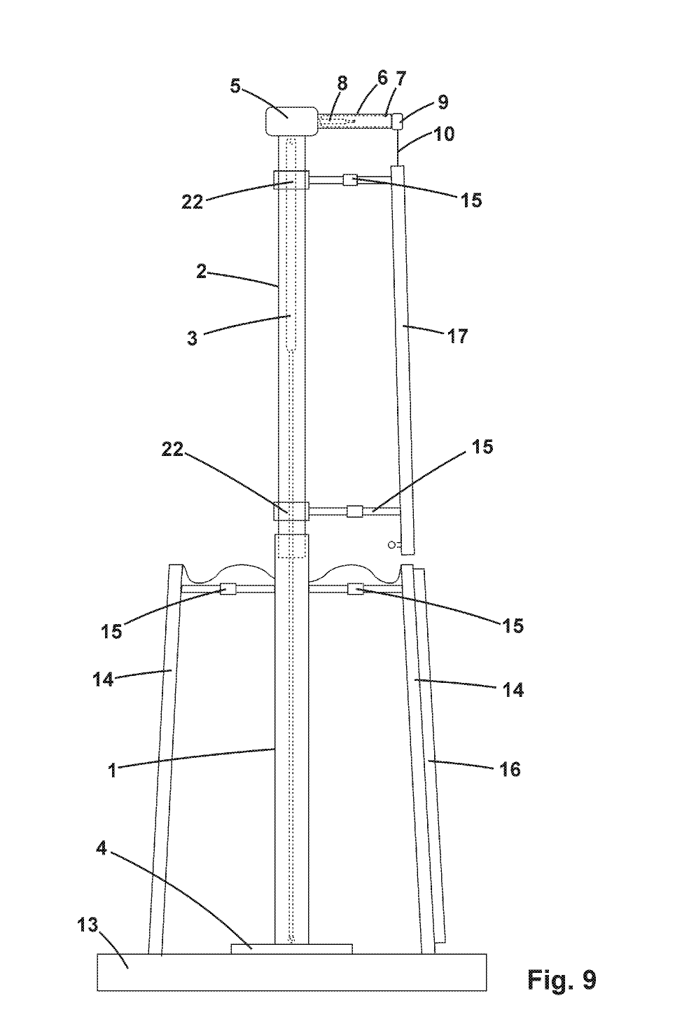

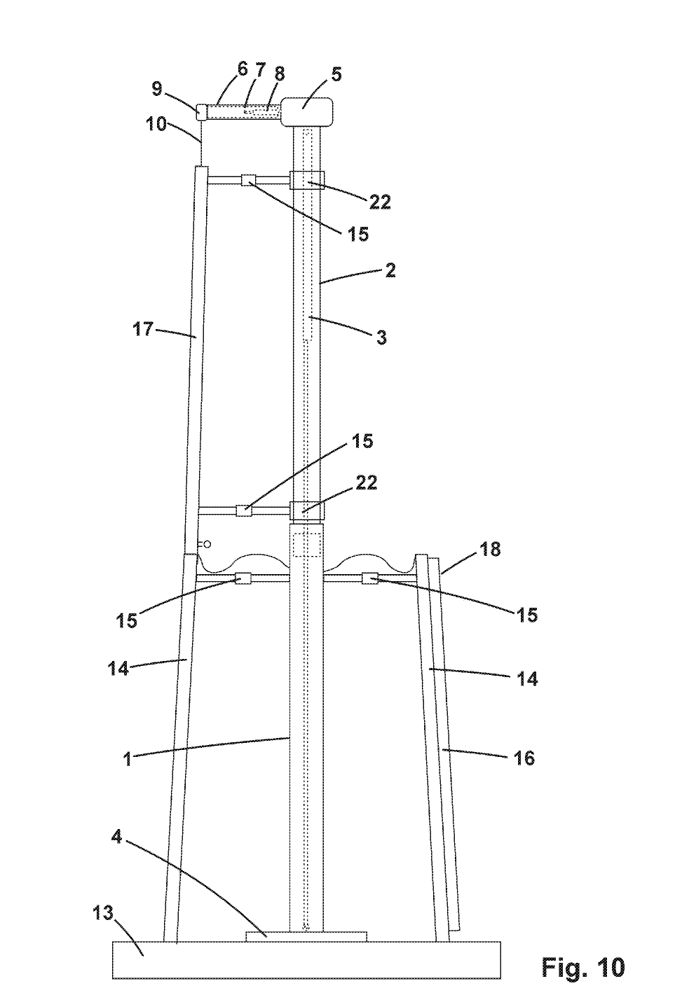

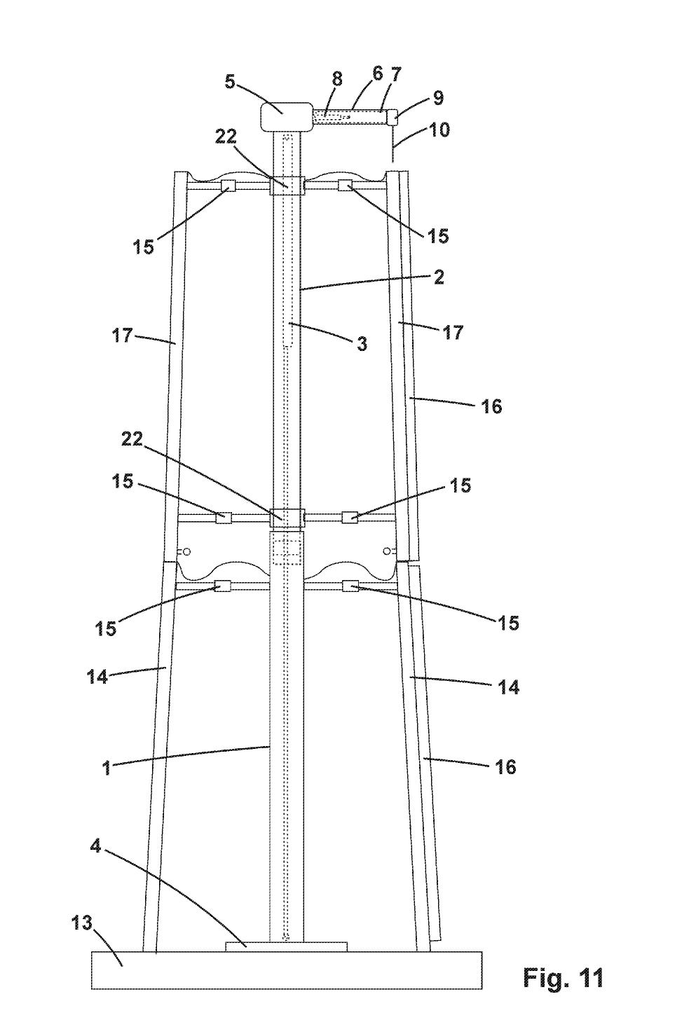

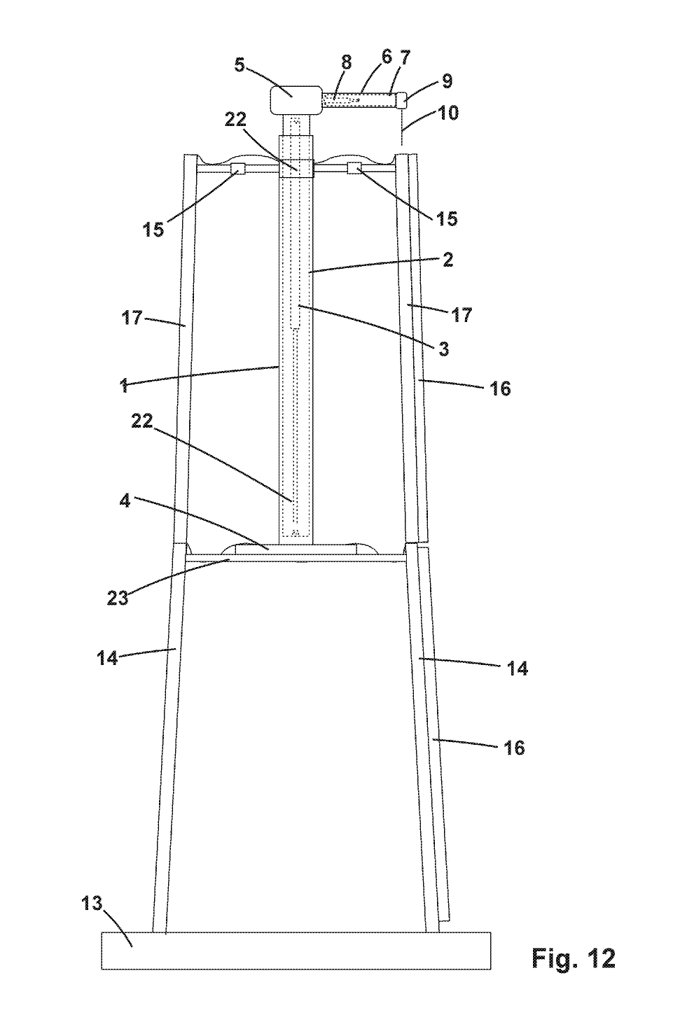

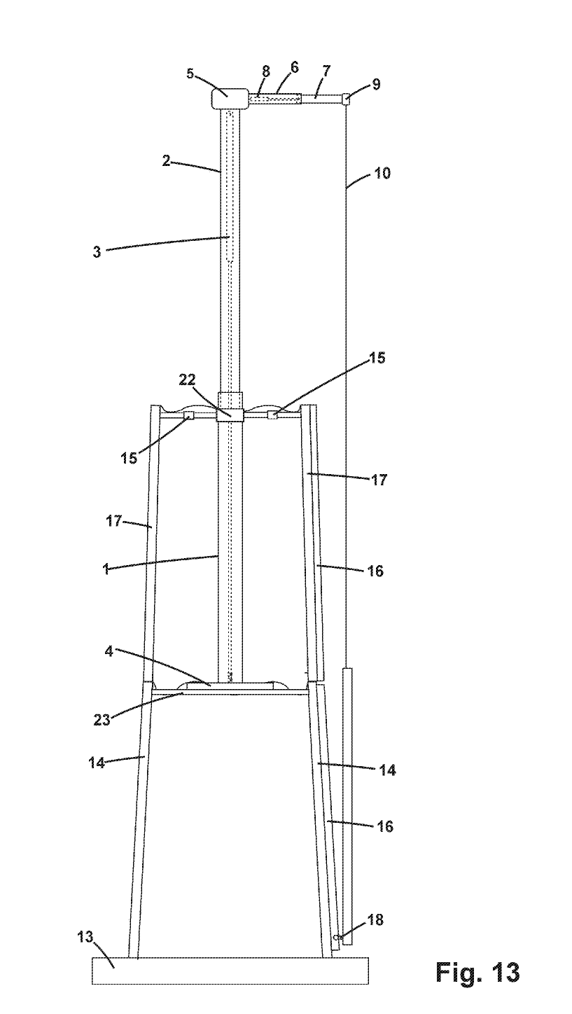

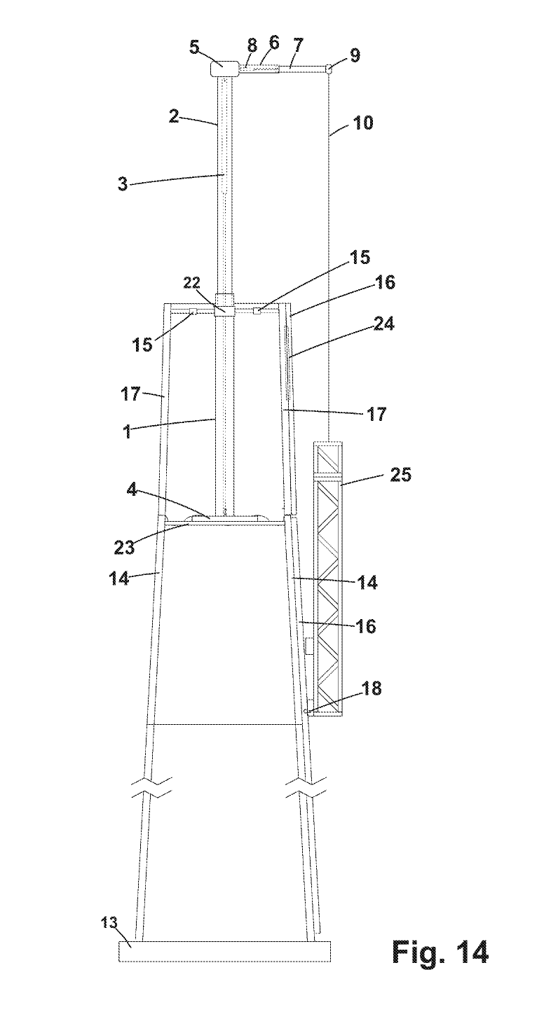

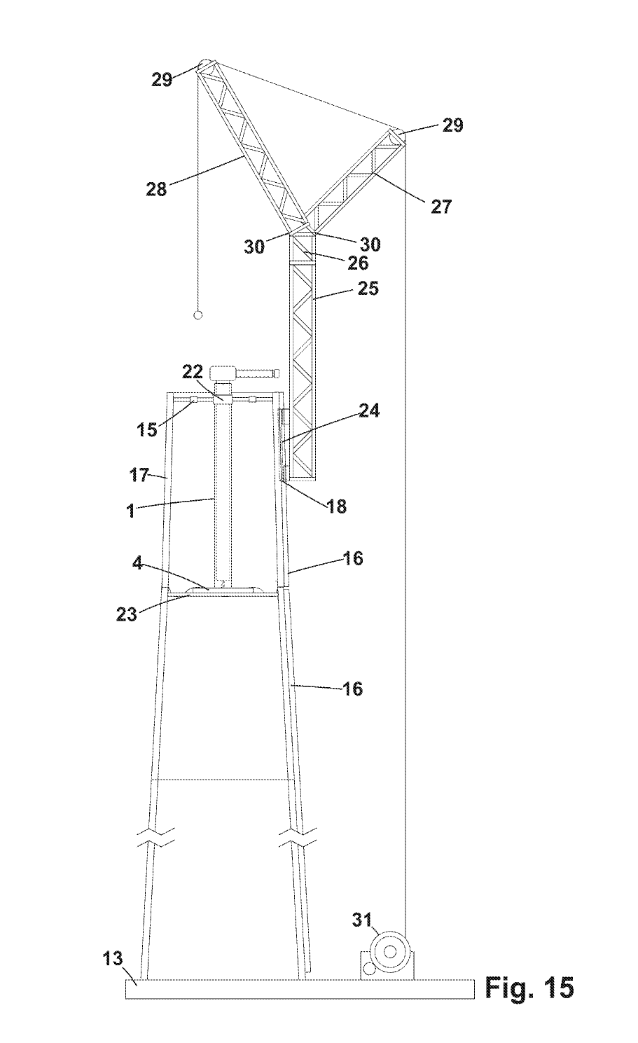

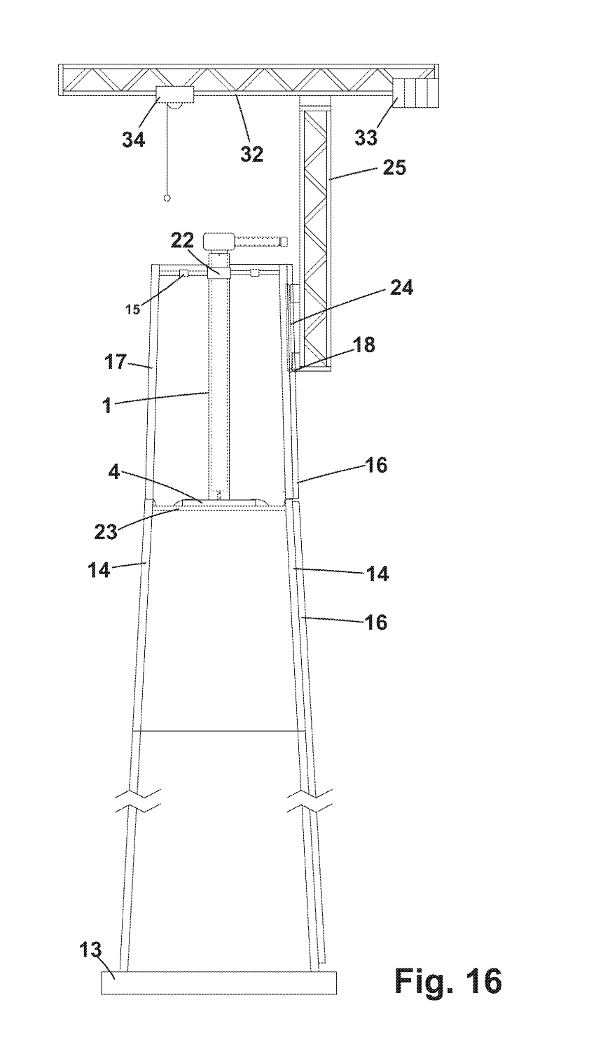

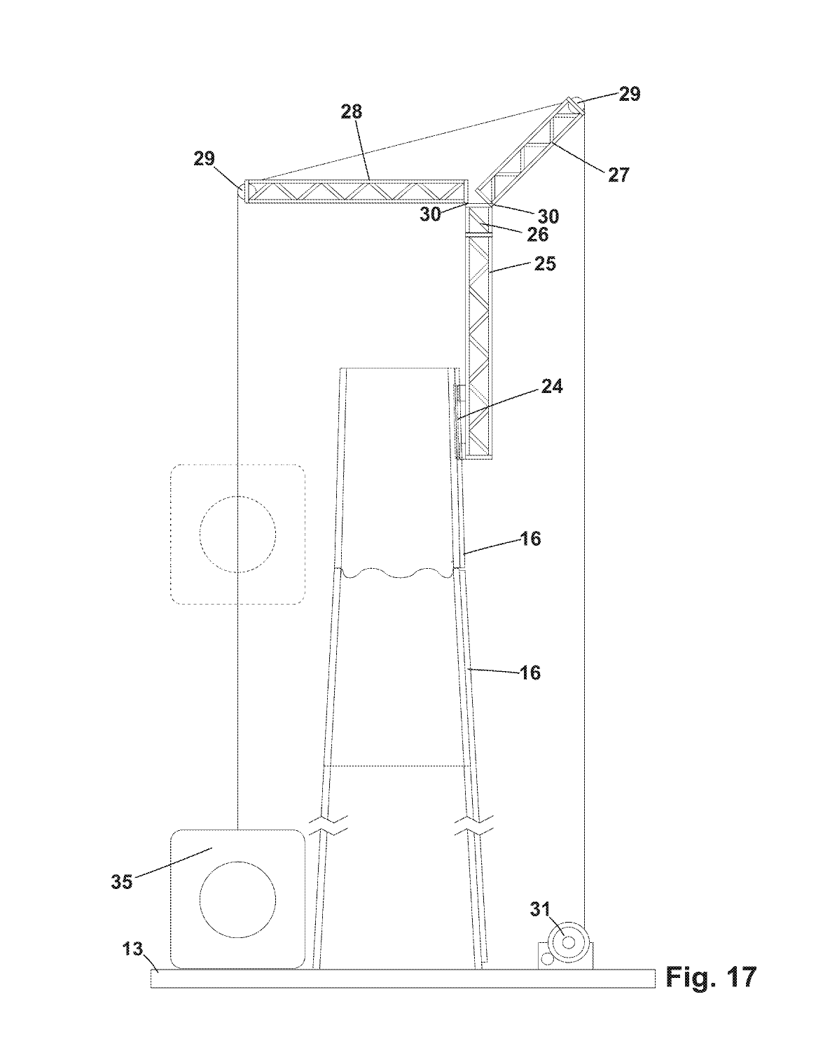

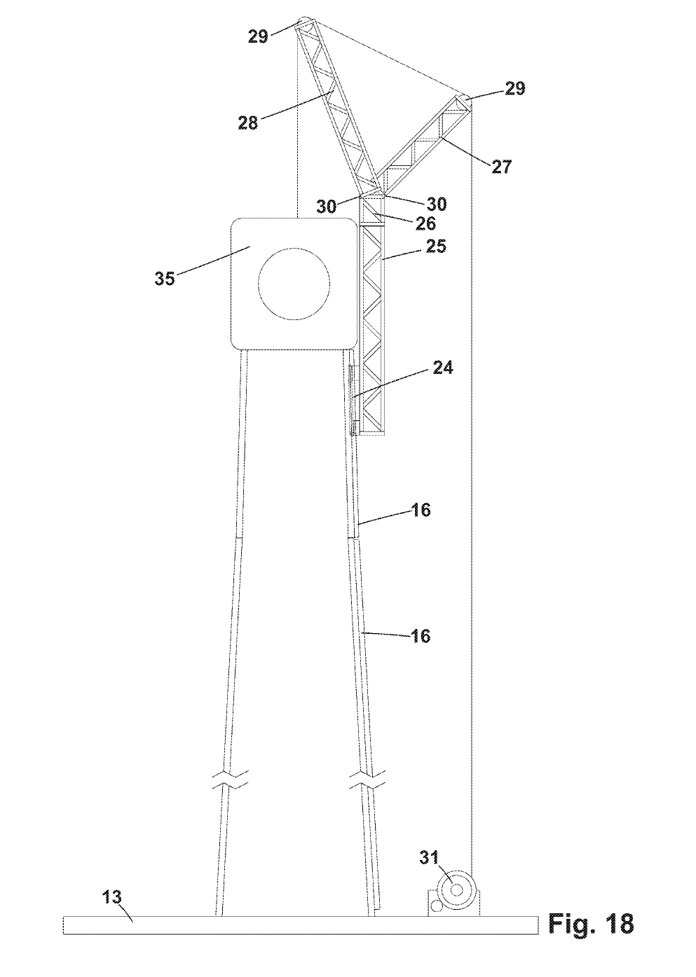

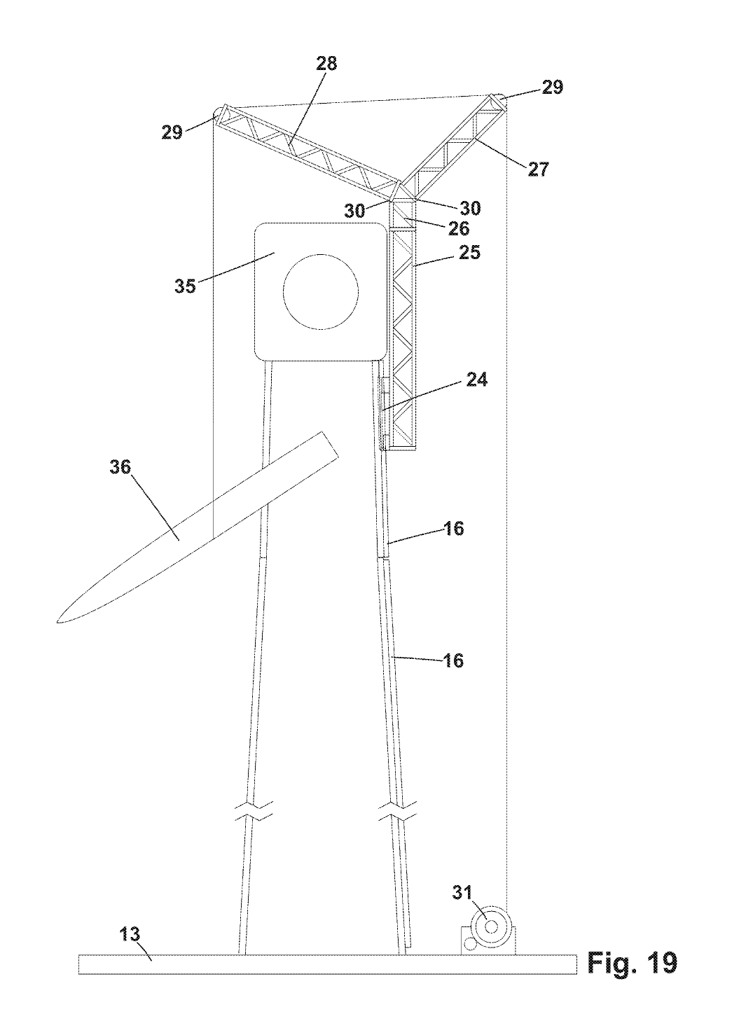

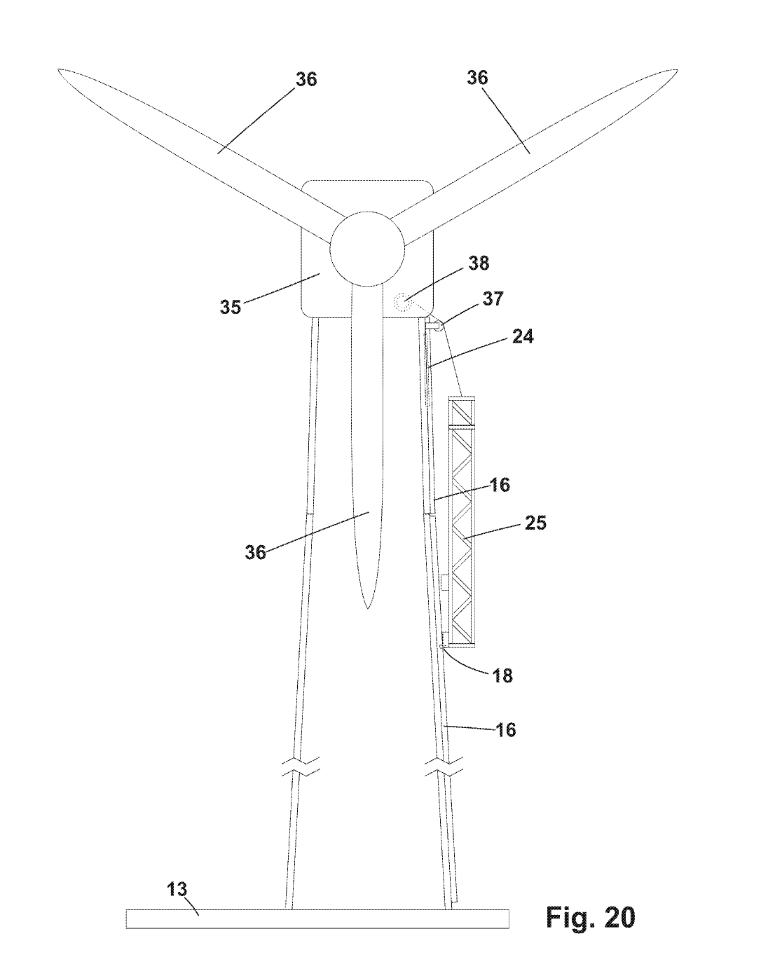

### PREFERRED EMBODIMENT OF THE INVENTION

The self-climbing, telescopic crane for mounting pre-fabricated concrete towers that is the object of this invention, basically comprises, as can be seen in the attached drawing, an external vertical column (1), terminated at the bottom in a support (4), and an internal vertical column (2) that can move vertically via one or several actuators (3). The top part of the internal vertical column (2) terminates in a horizontally rotatable capstan (5) associated with a horizontal arm, terminating at the opposite end in a pulley (9) through which the hoist cable (10) moves.

The horizontal arm associated with the capstan (5) preferably consists of an external tube (6) joined to the capstan (5) and an internal tube (7) with the pulley (9) at one end, said internal tube (7) moving horizontally in a telescopic manner in relation to the external tube (6) via one or several actuators (8). An alternative embodiment is envisaged in which the horizontal arm associated with the capstan (5) is formed by a tube (11) with the pulley (9) at one end, the inclination of the tube (11) being varied in relation to the capstan (5) via a rotation means, together with one or several actuators (12) thereby enabling the effective length of the arm to be varied.

The height of the external vertical column (1) and the internal vertical column (2) shall be preferably slightly higher than the height of one section of the tower to be mounted.

In all or in some of the mounting phases, it is envisaged the optional use of a work platform (19), that moves vertically and horizontally, associated with the external vertical column (1) via a collar (20) and mechanical elevating means (21), that allow the operators to perform the internal tasks of coupling, concreting, tensioning cables and sealing between the pre-fabricated concrete elements.

This self-climbing telescopic crane involves a specific method of mounting a pre-fabricated concrete tower that comprises the following phases.
a first phase of mounting the crane,
a second phases of mounting the first section of the tower,
a third phase of elevating the crane,
a fourth phase of mounting the following section of the tower and
a fifth phase of hoisting the crane,
the third and fourth phases being repeated for each of the tower sections,
and finishing with a sixth phase of dismantling the crane.

The first phase of mounting the crane involves attaching the support (4) of the external vertical column (1) to the concrete footing (13) and subsequently assembling the rest of the elements that form the crane, in the minimum height position with the internal vertical column (2) fully inserted inside the external vertical column (1), with the aid of another small, conventional external crane.

The second phase of mounting the first section of the tower comprises the adjacent stacking of the pre-fabricated concrete elements (14) supported at their top part by telescopic horizontal bracing members (15) on the top part of the external vertical column (1) in such a way that they form the tower section around the crane, with the crane remaining inside, at least one of the pre-fabricated concrete elements (14) having one or several guide rails (16) arranged vertically on its outer wall.

The third phase of elevation of the crane comprises the telescopic extension of the internal vertical column (2) inside the external vertical column (1) by the effect of the actuators (3), until its maximum height is reached.

The fourth phase of mounting the next section of the tower comprises:
in a first step, the extending of the horizontal arm associated with the capstan (5) to its maximum extension,
in a second step, the partial elevation of a pre-fabricated concrete element (17), guided at its bottom part, by one or several rollers (18) arranged on the inner bottom part and which slide along the guide rail or guide rails (16),
in a third optional step, the support of the top part of the pre-fabricated concrete element (17) on the internal vertical column (2) by means of a bracing member (15) and a sliding collar (22),
in a fourth step, the complete elevation of the pre-fabricated concrete element (17) over the pre-fabricated concrete element (14) of the bottom section, with the roller (18) exiting the guide rail or guide rails (16),
in a fifth step of supporting the bottom part of the pre-fabricated concrete element (17) on the internal vertical column (2) by means of a bracing member (15) and a sliding collar (22),
in a sixth step of rotating the pre-fabricated concrete element (17) by the rotation of the capstan (5) and of the horizontal arm until the pre-fabricated concrete element (17) is placed in its position,
in a seventh step of the descent of the pre-fabricated concrete element (17) until it rests on the pre-fabricated concrete element (14) of the bottom section, the above steps being repeated until the section is completed, with at least one of the pre-fabricated concrete elements (17) having one or several guide rails (16) vertically arranged on its outer wall.

The fifth phase of lifting the crane comprises a first step of removing the bracing members (15) and collar (22) located on the top part of the pre-fabricated concrete element (14) of the bottom section, and on the bottom part of the pre-fabricated concrete element (17) of the top section, as well as releasing the support (4) of the footing (13), a second step of the elevation of the external vertical column (1) via the actuators (3), keeping the internal vertical column (2) fixed at its top part by means of the rest of the bracing members (15) until the support (4) is at the height of the top part of the first section, a third step of placing a platform (23) at the top part of the lower segment of the tower and a fourth step of attaching the support (4) to the platform (23).

The sixth phase of dismantling the crane comprises a stage of mounting an auxiliary crane structure (25) that temporarily uses the previously mounted tower as the crane tower, with a rotatable top part (26), on the outside of the last top segment of the tower, followed by a stage of releasing the support (4) of the footing (13), removing the bracing members (15) and remaining collars (22) and extracting the rest of the crane elements and platform (23) from the last segment of the tower via the auxiliary crane structure (25), followed by a stage of hoisting and mounting the nacelle (35) and the blades (36) by means of said auxiliary crane structure (25), finishing off with a stage of dismantling the auxiliary crane structure (25) and, optionally, the auxiliary elements that may remain such as guide rails (16), support plates (24), return pulley (37), etc. . . .

The stage of mounting the auxiliary crane structure (25) on the outside of the last top segment of the tower comprises a step in which the internal vertical column (2) extends telescopically through the inside of the external vertical column (1) due to the effect of the actuators (3), until it reaches its maximum height, followed by a step of extending the horizontal arm associated with the capstan (5) to its maximum extension. Following this there is a step of elevating the auxiliary crane structure (25), preferably of the lattice type, to reduce its weight, guided on its bottom part by one or several rollers (18), arranged on the inner bottom part and which slide along the guide rail or guide rails (16), followed by a step of attaching the auxiliary crane structure (25) to one or several support plates (24) that are inserted in the outer side of a pre-fabricated concrete element (17) of the top section, maintaining a separation distance with the tower. If a dual-arm crane structure is used, this stage finishes with a step of opening the two arms (26,27) of the auxiliary crane structure (25), previously folded by the rotation means (30) during the ascent, mounting of the dual capstan (31) near to the base of the tower and joined to the concrete footing (13), and laying the cables through the pulleys (29). In the alternative case of using a crane structure with horizontal arm, it finishes with a step of mounting the horizontal arm (32), the counterweights (33) and the movable capstan (34).

The stage of hoisting and mounting the nacelle (35) and the blades (36) comprises a first step of elevating the nacelle (35), preferably in one piece, along the side of the tower by means of the auxiliary crane structure (25), a second step of positioning over the top part of the tower and attachment to it, a third step of the lateral rotation of the nacelle (35) and of the auxiliary crane structure (25) to facilitate the following steps, followed by a step of elevation, also via the auxiliary crane structure (25), for each of the blades (36) and mounting on the nacelle (35).

Lastly, once all of the wind turbine elements have been mounted, the stage of dismantling the auxiliary crane structure (25) comprises a step of attaching a return pulley (37) at the top part of the tower, next to the auxiliary crane structure (25), a second step of folding the two arms (26,27) or the horizontal arm (32), a third step of attachment by means of a cable between the auxiliary crane structure (25) and the auxiliary capstan (38) that is in the nacelle (35), or the dual capstan (31), a fourth step of releasing the auxiliary crane structure (25) from the support plate or support plates (24) and concluding with a fifth step of the descent of the auxiliary crane structure (25), guided on its bottom part by one or several rollers (18) arranged on the inner bottom part and which slide along the guide rail or guide rails (16), to the ground.

Alternatively, the sixth phase of dismantling the crane may consist solely of releasing the support (4) from the footing (13), removing the bracing members (15) and the remaining collars (22), and removing the rest of the crane elements and the platform (23) from the last segment of the tower using a conventional external crane, then placing them on the ground.

1. Self-climbing, telescopic crane for mounting pre-fabricated concrete towers characterized in that it comprises an external vertical column (1), terminated at the bottom in a support (4), and an internal vertical column (2) that can move vertically via one or several actuators (3). The top part of said internal vertical column (2) terminates in a horizontally rotatable capstan (5) associated with a horizontal arm, terminating at the opposite end in a pulley (9) through which the hoist cable (10) moves.

2. Self-climbing, telescopic crane for mounting pre-fabricated concrete towers, according to claim 1, wherein the horizontal arm associated with the capstan (5) is formed by an external tube (6) joined to the capstan (5) and an internal tube (7) with the pulley (9) at one end, said internal tube (7) being able to move horizontally in relation to the external tube (6) via one or several actuators (8).

3. Self-climbing, telescopic crane for mounting pre-fabricated concrete towers, according to claim 1, wherein the horizontal arm associated with the capstan (5) is formed by a tube (11) with the pulley (9) at one end, the inclination of the tube (11) being variable, via a rotation means, in relation to the capstan (5) together with one or several actuators (12).

4. Self-climbing, telescopic crane for mounting pre-fabricated concrete towers, according to claim 1, wherein it includes a work platform (19) that moves vertically and horizontally, associated with the external vertical column (1) via a collar (20) and mechanical elevating means (21).

5. Method for mounting a pre-fabricated concrete tower by means of a self-climbing, telescopic crane such as that described in claim 1, characterized in that it comprises a first phase of mounting the crane, a second phase of mounting the first section of the tower, a third phase of elevating the crane, a fourth phase of mounting the following section of the tower, a fifth phase of lifting the crane, the third and fourth phases being repeated for each of the tower sections, and finishing with a sixth phase of dismantling the crane.

6. Method for mounting a pre-fabricated concrete tower, according to claim 5, wherein the first phase of mounting the crane entails attaching the support (4) of the external vertical column (1) to the concrete footing (13) and subsequently assembling the rest of the elements that form the crane, in the minimum height position with the internal vertical column (2) fully inserted inside the external vertical column (1), with the aid of another small, conventional external crane.

7. Method for mounting a pre-fabricated concrete tower, according to claim 5, wherein the second phase of mounting the first section of the tower comprises the adjacent stacking of the pre-fabricated concrete elements (14) supported at their top part by telescopic horizontal bracing members (15) on the top part of the external vertical column (1) in such a way that they form the tower section around the crane and the crane remains inside, at least one of the pre-fabricated concrete elements (14) having one or several guide rails (16) arranged vertically on its outer wall.

8. Method for mounting a pre-fabricated concrete tower, according to claim 5, wherein the third phase of elevation of the crane comprises the telescopic extending of the internal vertical column (2) inside the external vertical column (1) by the effect of the actuators (3), until its maximum height is reached.

9. Method for mounting a pre-fabricated concrete tower, according to claim 5, wherein the fourth phase of mounting the following section of the tower comprises, in a first step, the extending of the horizontal arm associated with the capstan (5) to its maximum extension, in a second step, the partial elevation of a pre-fabricated concrete element (17) guided at its bottom part by one or several rollers (18) arranged on the inner bottom part and which slide along the guide rail or guide rails (16), in a third optional step of supporting the top part of the pre-fabricated concrete element (17) on the internal vertical column (2) by means of a bracing member (15) and a sliding collar (22), in a fourth step of fully elevating the pre-fabricated concrete element (17) over the pre-fabricated concrete element (14) of the bottom section, the roller (18) exiting the guide rail or guide rails (16), in a fifth step of supporting the bottom part of the pre-fabricated concrete element (17) on the internal vertical column (2) by means of a bracing member (15) and a sliding collar (22), in a sixth step of rotating the pre-fabricated concrete element (17) by the rotation of the capstan (5) and of the horizontal arm until the pre-fabricated concrete element (17) is placed in its position, in a seventh step of the descent of the pre-fabricated concrete element (17) until it rests on the pre-fabricated concrete element (14) of the bottom section, the previous steps being repeated until the section is completed, also at least one of the pre-fabricated concrete elements (17) having one or several guide rails (16) vertically arranged on its outer wall.

10. Method for mounting a pre-fabricated concrete tower, according to claim 5, wherein the fifth phase of lifting the crane comprises a first step of removing the bracing members (15) and collar (22) located on the top part of the pre-fabricated concrete element (14) of the lower section, and on the bottom part of the pre-fabricated concrete element (17) of the upper section, as well as releasing the support (4) of the footing (13), a second step of elevating the external vertical column (1) via the actuators (3), keeping the internal vertical column (2) fixed at its top part by means of the rest of the bracing members (15) until the support (4) is at the height of the top part of the first section, a third step of placing a platform (23) at the top part of the lower segment of the tower and a fourth step of attaching the support (4) to the platform (23).

11. Method for mounting a pre-fabricated concrete tower, according to claim 5, wherein the sixth phase of dismantling the crane entails releasing the support (4) from the footing (13), removing the bracing members (15) and the remaining collars (22), and removing the rest of the crane elements and the platform (23) from the last segment of the tower using a conventional external crane and then placing them on the ground.

12. Method for mounting a pre-fabricated concrete tower, according to claim 5, wherein the sixth phase of dismantling the crane comprises a stage of mounting an auxiliary crane structure (25) with a rotatable top part (26), on the outside of the last upper segment of the tower, followed by a stage of releasing the support (4) of the footing (13), removing the bracing members (15) and remaining collars (22) and removing the rest of the crane elements and platform (23) from the last segment of the tower via the auxiliary crane structure (25), followed by a stage of hoisting and mounting the nacelle (35) and the blades (36) by means of said auxiliary crane structure (25), finishing off with a stage of dismantling the auxiliary crane structure (25).

13. Method for mounting a pre-fabricated concrete tower, according to claim 12, wherein the stage of mounting an auxiliary crane structure (25) on the outside of the last upper segment of the tower comprises a step of the telescopic extending of the internal vertical column (2) inside the external vertical column (1) by the effect of the actuators (3), until its maximum height is reached, followed by a step of extending the horizontal arm associated with the capstan (5) to its maximum extension, continuing with a step of elevating the auxiliary crane structure (25) guided at its bottom part by one or several rollers (18) arranged on the inner bottom part and which slide along the guide rail or guide rails (16), followed by a step of attaching the auxiliary crane structure (25) to one or several support plates (24) that are inserted in the outer side of a pre-fabricated concrete element (17) of the top section, maintaining a separation distance with the tower, finishing, in the case of a dual-arm crane structure, with a step of opening the two arms (26,27) of the auxiliary crane structure (25), previously folded by the rotation means (30), during the ascent, the mounting of the dual capstan (31) near to the base of the tower and joined to the concrete footing (13), and the laying of the cables through the pulleys (29), or, in the case of a crane structure with horizontal arm, with a step of mounting the horizontal arm (32), the counterweights (33) and the movable capstan (34).

14. Method for mounting a pre-fabricated concrete tower, according to claim 12, wherein the stage of hoisting and mounting the nacelle (35) and the blades (36) comprises a first step of elevating the nacelle (35) up the side of the tower, by means of the auxiliary crane structure (25), a second step of positioning at the top part of the tower and attachment to it, a third step of the lateral rotation of the nacelle (35) and of the auxiliary crane structure (25) to facilitate the next steps, followed by a step of elevating, also via the auxiliary crane structure (25), each of the blades (36) and mounting on the nacelle (35).

15. Method for mounting a pre-fabricated concrete tower, according to claim 12, wherein the stage of dismantling the auxiliary crane structure (25) comprises a step of attaching a return pulley (37) at the top part of the tower, next to the auxiliary crane structure (25), a second step of folding the two arms (26,27) or the horizontal arm (32), a third step of attachment by means of a cable between the auxiliary crane structure (25) and the auxiliary capstan (38) in the nacelle (35), or the dual capstan (31), a fourth step of releasing the auxiliary crane structure (25) from the support plate or support plates (24) and concluding with a fifth step of the descent of the auxiliary crane structure (25), guided at its bottom part by one or several rollers (18) arranged on the inner bottom part and which slide along the guide rail or guide rails (16), to the ground.
